(19) United States
(12) Patent Application Publication
(10) Pub. No.: US 2011/0096158 A1
(43) Pub. Date: Apr. 28, 2011

(54) LIQUID CRYSTAL ARRAY INSPECTING APPARATUS

(75) Inventor: Masamichi Nagai, Kyoto (JP)

(73) Assignee: SHIMADZU CORPORATION, Kyoto (JP)

(21) Appl. No.: 12/999,050

(22) PCT Filed: Jun. 17, 2008
(86) PCT No.: PCT/JP2008/061024

§ 371 Date: Dec. 14, 2010

(51) Int. Cl. H04N 7/18

(52) U.S. Cl. 348/95; 348/E07.085

(57) ABSTRACT

A liquid crystal array inspection apparatus for two-dimensional scanning on a liquid crystal substrate. It includes a stage for mounting the liquid crystal substrate; an imaging device provided above and distantly from the stage; an imaging control part for controlling the imaging of the imaging device; a stage driving part for driving the stage in a Y direction; an encoder for detecting a rotation state of a drive motor of the stage driving part; an imaging-start position reaching detection part for detecting that the liquid crystal substrate reaches the imaging-start positions in the Y direction in forward and return courses on the stages based on a detection quantity and an imaging range of the encoder; and an imaging-start trigger signal generating part for generating an imaging-start trigger signal to start the imaging by the imaging control part based on an output from the imaging-start position reaching detection part.

### BACKGROUND OF THE INVENTION

1. Field of the Invention

The present invention relates to a liquid crystal array inspection apparatus for inspecting a liquid crystal array by using an imaging picture obtained by imaging the liquid crystal substrate, and more particularly to a liquid crystal array inspection apparatus, for moving a liquid crystal substrate to-and-fro in a Y direction, scanning along an X direction in the forward and return courses, and acquiring an imaging picture.

2. Description of Related Art

For a liquid crystal array inspection apparatus, the imaging picture obtained by imaging the liquid crystal substrate may be an optical image obtained by imaging in an optical manner or an imaging picture obtained by scanning the substrate in a two-dimensional manner with a charged particle beam, such as an electron beam or ion beam.

For example, a known substrate inspection apparatus applies an inspection signal on an object to be inspected, such as a liquid crystal substrate array, and performs a substrate inspection based on an imaging picture obtained by scanning the substrate in a two-dimensional manner with a charged particle beam such as an electron beam or ion beam on.

In the manufacturing process of a Thin Film Transistor (TFT) array substrate used in a TFT display device, an inspection is performed on the manufactured TFT array substrate to determine whether the TFT array substrate is correctly driven. During the inspection of the TFT array substrate, the electron beam, for example, is used as the charged particle beam to scan the TFT array substrate so as to acquire an imaging picture, and the substrate is inspected based on the imaging picture (Patent Documents 1, 2).

In order to enable the electron beam to scan the array in a two-dimensional manner on the liquid crystal substrate, the electron beam is moved to-and fro in an X direction, and the stage is moved in a Y direction.

For a scanning achieved with an electron beam and a movement of the stage, the electron beam emitted from a single electron gun may scan with precision, but the scanning width is limited. Therefore, typically, the overall scan range of a substrate is divided into a plurality of portions and an electron gun is arranged for each portion. Moreover, the following control method is known, in which the scan range of each electron guns is divided into a plurality of paths arranged in the X direction, and in each path, translocation of the stage by a translocation width equivalent to a width of one pixel of the liquid crystal substrate in the Y direction and scanning with a beam with a scan width equivalent to a width of one pixel in the X direction are alternately performed, so as to acquire the imaging picture along the path.

FIGS. 11(a) to 11(c) are views illustrating the scanning of a liquid crystal substrate with electron beams. In FIGS. 11(a) to 11(c), multiple electron guns (GUN1, GUN2, etc.) are disposed in the X direction of the liquid crystal substrate at a specified interval, and each electron gun emits an electron beam on the liquid crystal substrate. During the emission of the electron beam, the electron guns are disposed in one of the paths (Path 1 to Path 4 in FIGS. 11(a)-11(c)) on the liquid crystal substrate for scanning with the electron beam having a width Dx. Through the to-and-fro motion of the electron beam of the electron gun, the electron beam scans in a unit of the path. After the imaging is performed as the electron beam moves in the forward course of the path, the stage moves so that the imaging of the adjacent paths is performed as the electron beam moves in the return course. When the stage is moved, the stage is only moved by a stage-movement-width Lx equivalent to the width of the path.

FIG. 11(b) shows the scan state of Path 2, in the forward course, Path 1 of FIG. 11(a) is scanned and imaged, so the stage is only moved by the stage-movement-width Lx. Then, in the return course, Path 2 is scanned and imaged. In addition, FIG. 11(c) shows the following condition, in which the stage is moved only by the stage-movement-width Lx from the position of FIG. 11(b), and in the forward course, Path 3 is scanned and imaged. In this manner, all paths set on the liquid crystal substrate are scanned.

In the scanning of each path, an imaging device is used to perform the imaging on the liquid crystal substrate and acquire an imaging picture. By combining the imaging pictures obtained in the scan, the imaging picture of the entire substrate is acquired.

By combining the scanning in the X direction and the stage movement in the Y direction, the liquid crystal substrate is imaged in a two-dimensional manner.

During the course of the stage movement in the Y direction, the imaging position is located based on the stage position. When the stage position is used to locate the imaging position, an encoder is connected to a drive motor for driving the stage, and a Z-phase signal of the encoder is used to determine the imaging-start position.
Patent Document 1: Japanese Laid-open Patent Publication No. 2004-271516
Patent Document 2: Japanese Laid-open Patent Publication No. 2004-309488

The Z-phase signal of the encoder is a signal outputted only once after the motor rotates for one cycle. Therefore, for example, when the motor rotates for one cycle and the ball screw moves for one lead width, the locating precision of the imaging-start position is within the unit of the lead width.

For the lead width of the ball screw, for example, the 16 mm lead width is known. When the ball screw is used to drive the stage, the imaging-start position is merely adjusted at the interval of 16 mm. In order to locate a position that is finer than the lead width of the ball screw, the installation position of the motor must be mechanically adjusted.

As described above, when the liquid crystal substrate moves to-and-fro in the forward course and the return course along the Y direction and an imaging picture is acquired, the imaging-start position in the forward course and the imaging-start position in the return course must be located. However, when the Z-phase signal of the encoder is used to locate the imaging-start positions in the paths of the forward course and the return course, the precision in locating the imaging-start positions depends on the interval of the Z-phase signal, and according to the position relation between an invert position, where the moving direction is reversed from the forward course to the return course or from the return course to the forward course, and the output position of the Z-phase signal, the displacement may be generated at the imaging-start position.

The width of the displacement in the forward course and the return course is smaller than a mechanically adjustable width, so it is difficult to adjust the imaging-start position correctly.

### SUMMARY OF THE INVENTION

Accordingly, the objective of the present invention is to solve the problem in the prior art, in which the imaging-start positions in the forward and return courses are adjusted when the liquid crystal substrate moves to-and-fro in the Y direction and imaging is performed.

In the present invention, instead of the Z-phase signal of the encoder, an A-phase signal and a B-phase signal which are shifted 90° relative to each other are used to generate an imaging-start trigger signal for starting the imaging, and the imaging-start trigger signal may be used to control the imaging device; accordingly, movement of the stage in the Y direction and the imaging are synchronized so as to adjust the imaging-start positions in the forward and return courses.

A liquid crystal array inspection apparatus of the present invention scans the liquid crystal substrate in a two-dimensional manner, acquires an imaging picture, and performs inspection on the liquid crystal substrate array based on the acquired imaging picture. The liquid crystal array inspection apparatus includes: a stage, for carrying the liquid crystal substrate and moving to-and-fro in a Y direction; an imaging device, configured above the stage and separated from the stage; an imaging control part, for controlling the imaging operation of the imaging device; a stage driving part, for driving the stage in the Y direction; an encoder, for detecting a rotation state of a drive motor of the stage driving part; an imaging-start position reaching detection part, for detecting that the liquid crystal substrate on the stage reaches the imaging-start positions of the forward and return courses in the Y direction based on a detection value and an imaging range of the encoder; and an imaging-start trigger signal generating part, for generating an imaging-start trigger signal for starting the imaging of the imaging control part based on an output of the imaging-start position reaching detection part.

The imaging control part receives a start trigger signal generated by the imaging-start trigger signal generating part, and the imaging device starts imaging; the Y direction positions of the stage in the forward and return trips and the imaging-start position of the imaging device are thereby synchronized. The synchronized control makes the imaging-start positions of the stage in the forward and return courses to be consistent with the imaging-start position of the imaging device.

The imaging-start position reaching detection part of the present invention includes: a counter part, for counting a count value equivalent to a moving distance of the stage according to a detection signal obtained after the A-phase signal and B-phase signal of the encoder are shifted 90° relative to each other; and a comparator, for comparing a value, equivalent to an end position value in the Y direction of an imaging range on the liquid crystal substrate, with the count value obtained by the counter part.

In the comparison operation of the comparator, when the value equivalent to the end position is consistent with the count value equivalent to the moving distance of the stage, the imaging-start trigger signal generating part of the present invention generates an imaging-start trigger signal after receiving a consistent signal generated by the comparator.

After the imaging control part receives the imaging-start trigger signal from the imaging-start trigger signal generating part, the imaging device starts imaging the liquid crystal substrate. In this manner, the imaging-start position of the imaging device on the liquid crystal substrate is consistent with the end position, which is the imaging-start positions of the forward course or the return course in the Y direction of the imaging range on the liquid crystal substrate.

In addition, the liquid crystal array inspection apparatus of the present invention calculates the imaging range according to the type of the substrate under inspection, and aligns the imaging-start position.

In this circumstance, the imaging-start position reaching detection part of the present invention includes a memory, for storing the imaging-range information of the liquid crystal substrate with relation to the substrate-type information that particularly designates the type of the liquid crystal substrate. The imaging range information contains the position information of the end position of the Y direction, and the position information of the imaging-start position in the forward course or the return course can be acquired.

The imaging-start position reaching detection part reads, based on the substrate-type information, the value equivalent to the end position in the Y direction of the imaging range on the liquid crystal substrate from the imaging-range information, stored in the memory, of the liquid crystal substrate. Further, in the comparator the read value equivalent to the end position in the Y direction is compared with the count value, and the liquid crystal substrate on the stage reaching the imaging-start position of the Y direction is detected, so as to generate the imaging-start trigger signal.

According to the construction, the imaging-range information of the different types of substrates is saved in the memory and is particularly designated by the substrate type information, and the imaging range information is read, thereby aligning the imaging-start position corresponding to the substrate under inspection.

In addition, for the liquid crystal array inspection apparatus of the present invention, when the position of the substrate on the liquid crystal array inspection apparatus is displaced, the pre-calculated alignment information of the liquid crystal substrate may be used for imaging the corrected displacement.

According to the construction, the imaging-start position reaching detection part includes a correction part for correcting the displacement in the imaging range. The correction part inputs the alignment information of the liquid crystal substrate, and adds the amount of displacement of the liquid crystal substrate of the alignment information to the imaging range position, so as to correct the end position in the Y direction of the imaging range on the liquid crystal substrate.

The imaging device using optical imaging to acquire the imaging picture or the imaging device that emits an electron beam for detecting the secondary electrons emitted by the liquid crystal substrate and acquires the imaging picture according to the detected strength is applicable to the present invention.

### EFFECT OF THE INVENTION

According to the present invention, when the liquid crystal substrate moves to-and-fro in the Y direction and performs the imaging operation, the imaging-start positions in the forward and return courses may be adjusted.

In addition, according to an aspect of the present invention, the imaging range may be calculated according to the type of the substrate that is under inspection so as to align the imaging-start position.

In addition, according to another aspect of the present invention, the alignment information of the liquid crystal substrate may be used to perform the imaging operation with the displacement being corrected.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating an exemplary construction of a liquid crystal array inspection apparatus of the present invention.

FIG. 2(a) to FIG. 2(g) illustrates views of signals of the imaging-start position reaching detection part and the Y-axis synchronizing unit.

FIG. 3 is a schematic view illustrating the to-and-fro stage movement of the liquid crystal array inspection apparatus of the present invention.

FIG. 4(a) and FIG. 4(b) are views illustrating the imaging operation based on the to-and-fro stage movement.

FIG. 5(a) and FIG. 5(b) are views illustrating the imaging operation based on the to-and-fro stage movement.

FIG. 6(a) and FIG. 6(b) are views illustrating the imaging operation based on the to-and-fro stage movement.

FIG. 7(a) and FIG. 7(b) are views illustrating the imaging operation based on the to-and-fro stage movement.

FIGS. 8(a) to 8(c) are views illustrating a correction on the displacement in which the displacement does not occur.

FIG. 9(a) and FIG. 9(b) are views illustrating a correction on the displacement, in which the substrate generates the displacement from the preset position in the upward direction in the figures.

FIG. 10(a) and FIG. 10(b) are views illustrating correction on the displacement, in which the substrate generates the displacement from the preset position in the downward direction in the figures.

FIG. 11(a) to FIG. 11(c) are views illustrating the scan of the electron beam on the liquid crystal substrate.

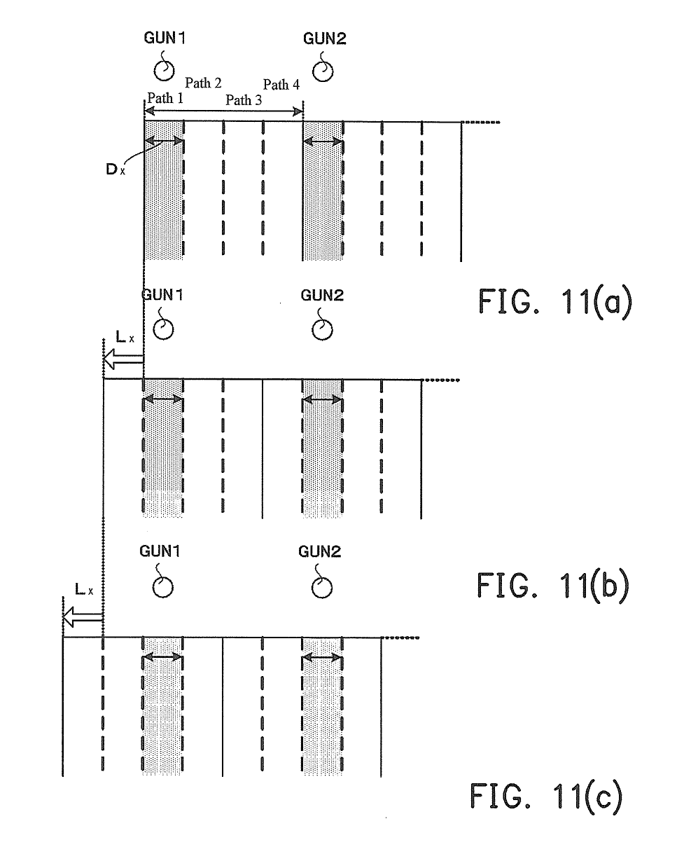

### DESCRIPTION OF THE SYMBOL LISTS

1 liquid crystal array inspection apparatus, 2 imaging device, 3 stage, 4 stage driving part, 5 encoder, 6 image processing part, 7 defect determining part, 11 imaging-start position reaching detection part, 11a counter part, 11b comparator, 11c memory, 11d input part, 11e setting part, 11f read and write part, 11g correction part, 20, stage, 21 imaging range, forward trip, 23 return trip, 24 imaging position, 25 imaging-finish range, 31 forward trip imaging-start position, 32 forward trip imaging-stop position, 33 return trip imaging-start position, 34 return trip imaging-stop position.

### DESCRIPTION OF THE EMBODIMENTS

Hereinafter, the embodiments of the present invention are illustrated in detail with reference to the drawings.

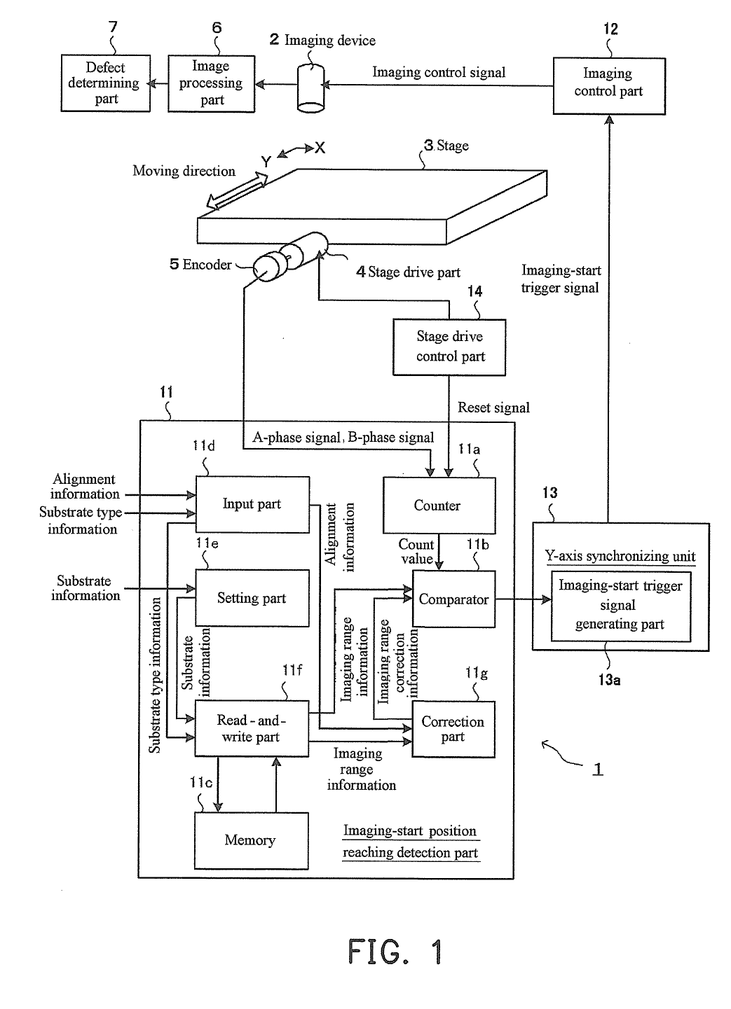

FIG. 1 is a schematic block diagram illustrating an exemplary construction of a liquid crystal array inspection apparatus of the present invention.

Furthermore, in the example of FIG. 1, the construction used for optically imaging a liquid crystal substrate and acquiring an imaging picture is illustrated; however, the present invention is also applicable to the following construction, in which an electron beam is emitted to the liquid crystal substrate to detect the secondary electrons discharged by the liquid crystal substrate and the imaging picture is acquired according to the detected strength.

In FIG. 1, the liquid crystal array inspection apparatus 1 includes a stage 3, for carrying the liquid crystal substrate (not shown); an imaging device, configured above the stage 3 and separated from the stage 3; an imaging control part 12, for controlling the imaging of the imaging device 2; an image processing part 6, for generating the imaging picture of the imaging range according to the imaging signal of the imaging device 2; and a defect determining part 7, for inspecting the defects of the array according to the imaging picture of the liquid crystal substrate generated by the image processing part 6.

Furthermore, the liquid crystal array inspection apparatus 1 includes a scan control part. In the situation when the scan control part acquires the imaging picture resulted from the scanning with an electron beam, the electron gun separated from the stage 3 and the detector for detecting the secondary electrons discharged by the liquid crystal substrate are configured above the stage 3, and the scan control part controls the scan of the electron beam projected by the electron gun in the X direction.

The stage 3 carries the liquid crystal substrate (not shown), and is driven by the stage driving part 4 to move in the X direction and the Y direction freely. The stage driving part 4 includes a drive motor and a ball screw etc., and the moving distance or moving direction of the stage is controlled by the drive control of the stage drive control part 14.

The encoder 5 is connected to the drive motor of the stage driving part 4. The encoder 5 takes the rotation state of the drive motor as the A-phase signal, B-phase signal, and Z-phase signal and outputs the signals. The A-phase signal and B-phase signal are shifted 90° relative to each other, and in the course of the drive motor rotates for one cycle, normally multiple signals are outputted. The A-phase signal and B-phase signal are used to detect the rotation speed of the drive motor or the rotation amount from the reference point. In addition, in the course of the drive motor rotates for one cycle, the Z-phase signal is outputted once. The encoder 5 detects the rotation state of the drive motor for driving the stage 3, so the moving state of the stage 3 may be known according to the output of the encoder 5.

In addition to a mechanism composed of the imaging device 2 and the stage 3, the liquid crystal array inspection apparatus 1 of the present invention further includes an imaging-start position reaching detection part 11 and a Y-axis synchronizing unit 13. The imaging-start position reaching detection part 11 detects that the liquid crystal substrate on the stage reaches the imaging-start position in the Y direction, and the Y-axis synchronizing unit 13 generates an imaging-start trigger signal based on the output of the imaging-start position reaching detection part 11. According to the construction, the imaging-start position of the liquid crystal substrate and the imaging of the imaging device are synchronized to be consistent.

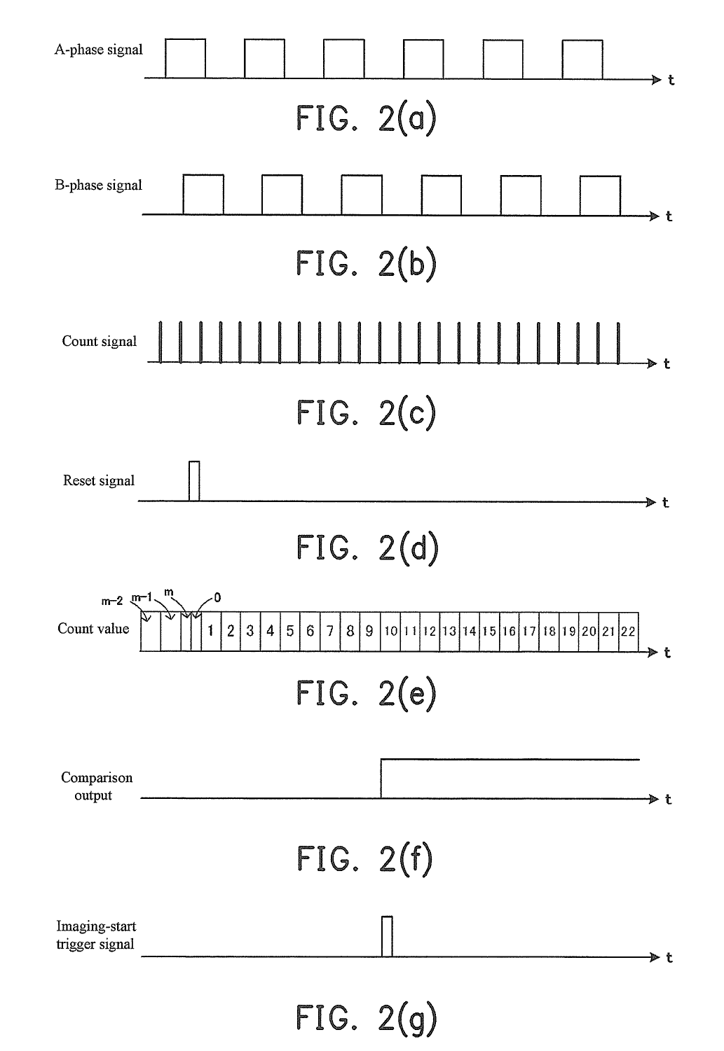

FIG. 2(a) to FIG. 2(g) illustrates views of signals of the imaging-start position reaching detection part 11 and the Y-axis synchronizing unit 13.

The imaging-start position reaching detection part 11 adopts a construction in which the liquid crystal substrate on the stage reaching the imaging-start position in the Y direction is detected. The imaging-start position reaching detection part 11 includes a counter part 11a, a comparator 11b, a memory 11c, and a read and write part 11f.

The counter part 11a inputs the A-phase signal and the B-phase signal from the encoder 5, and based on the A-phase signal and the B-phase signal, counts the count value equivalent to the position of the stage 3 in the Y direction. FIG. 2(a) shows the A-phase signal, and FIG. 2(b) shows the B-phase signal. The A-phase signal and B-phase signal are shifted 90° relative to each other and then are outputted.

The counter part 11a forms a counter signal at rising and falling points of the A-phase signal and the B-phase signal and counts the counter signal. FIG. 2(e) shows the count value obtained by counting the counter signal.

For example, a reset signal of the stage drive control part 14 may be used to reset the count value of the counter part 11a. FIG. 2(d) shows an example of the reset signal, and the counter signal of the FIG. 2(e) is reset to “0” from “m”. Furthermore, although the count value is reset to “0” by the reset at this time, for example, the count value may also be reset to a numeral other than “0”. The count value equivalent to the position of the stage 3 in the Y direction is set to a regulated value by the reset signal, thus indicating the position counted from the set position.

The comparator 11b compares the count value of the counter part 11a with the value of the imaging range. When the count value is consistent with the value of the imaging range, it is determined that the stage reaches the imaging-start position of the imaging range.

The imaging-start position information of the imaging range is stored in the memory 11c in advance, and a read-and-write part 11f is used to read the imaging-start position information of the imaging range. The read-and-write part 11f reads the imaging-start position information of the imaging range from the memory 11c, and the comparator 11b compares the imaging-start position information of the imaging range with the count value inputted by the counter part 11a. FIG. 2(f) shows the comparison output of the comparator 11b. Now, the imaging-start position of the imaging range is set to “10”. In this case, when the count value of FIG. 2(e) reaches “10”, the comparator 11b outputs the comparison output.

The comparison output of the comparator 11b is sent to the imaging-start trigger signal generating part 13a of the Y-axis synchronizing unit 13 to generate the imaging-start trigger signal (FIG. 2(g)). The imaging-start trigger signal is sent to the imaging control part 12, and the imaging device 2 starts imaging by means of the imaging control signal.

The imaging-start position information of the imaging range stored in the memory 11c is inputted through the setting part 11e, and the imaging-start position information can be written by the read-and-write part 11f. The setting part 11e may input the imaging-start position information of the imaging range and the substrate information related to the liquid crystal substrate and stores these information in the memory 11c. In addition to the imaging-start position information of the imaging range, the substrate information may include information, such as the substrate type of the liquid crystal substrate or the number or the size of the pixels or paths.

The imaging-start position information of the imaging range and the substrate type of the liquid crystal substrate are associated and stored in the memory 11c. Thus, the imaging-start position information of the imaging range of the corresponding substrate can be read by taking the substrate type of the liquid crystal substrate as a key word.

For example, the substrate type information may be inputted from the input part 11d, and the read-and-write part 11f reads the imaging-start position information of the corresponding substrate from the memory 11c by taking the substrate type information as the key word.

The imaging-start position reaching detection part 11 may include a correction part 11g. The correction part 11g performs a correction on the imaging-start position information read from the memory 11c based on the alignment information inputted from the input part 11d, and sends the corrected imaging-start position information to the comparator 11b.

The alignment information denotes the amount of displacement of the substrate relative to the stage. When the liquid crystal substrate (not shown) carried on the stage 3 is correctly located at the reference position of the stage 3 without displacement, the imaging range is determined based on the position determined according to imaging-start position information, thereby imaging the target imaging range on liquid crystal substrate. However, when a position of the liquid crystal substrate is displaced, a displacement is generated between the actually imaged imaging range and the target imaging range.

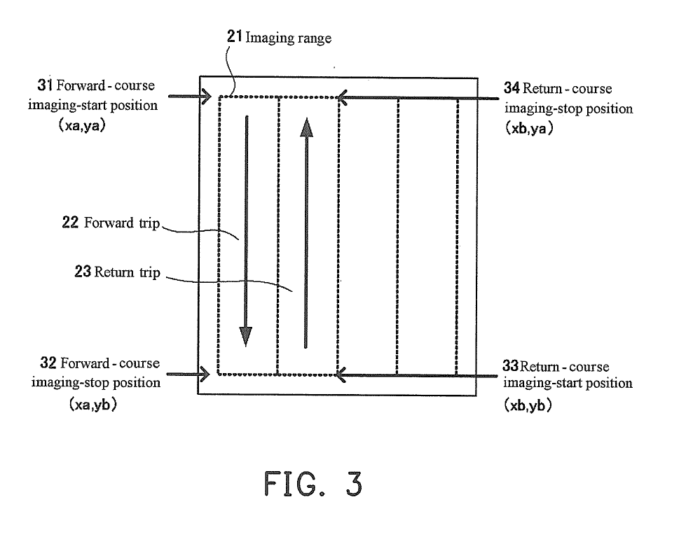

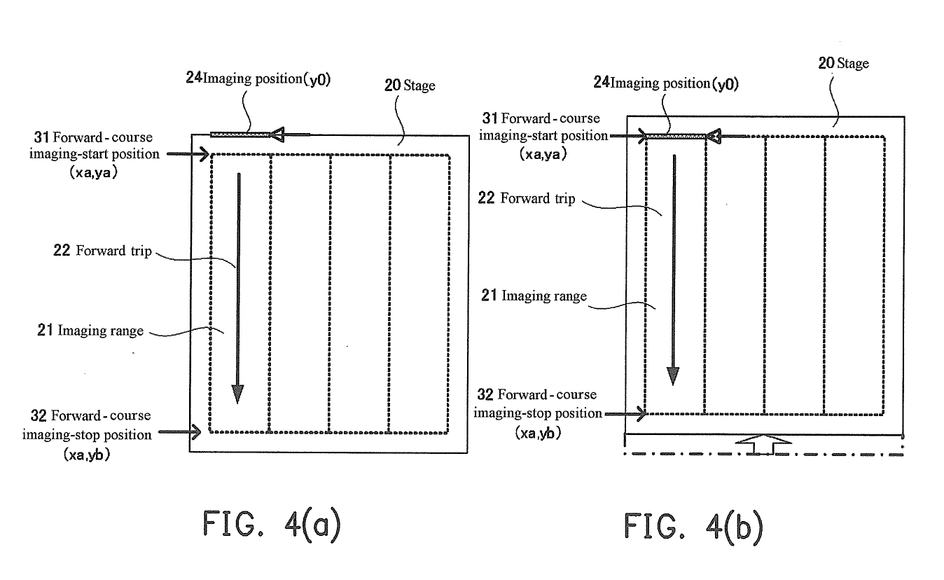

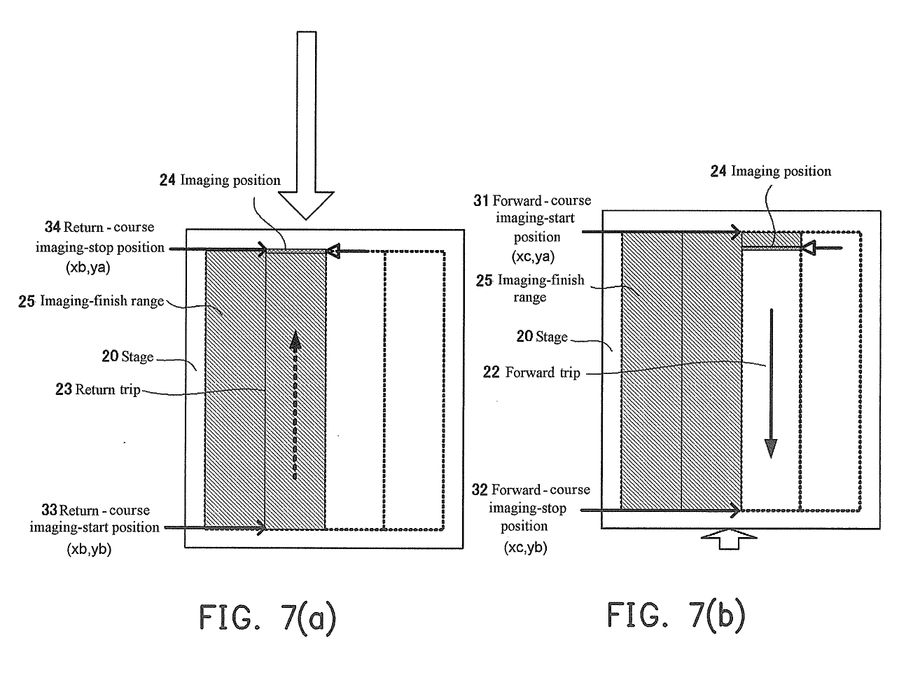

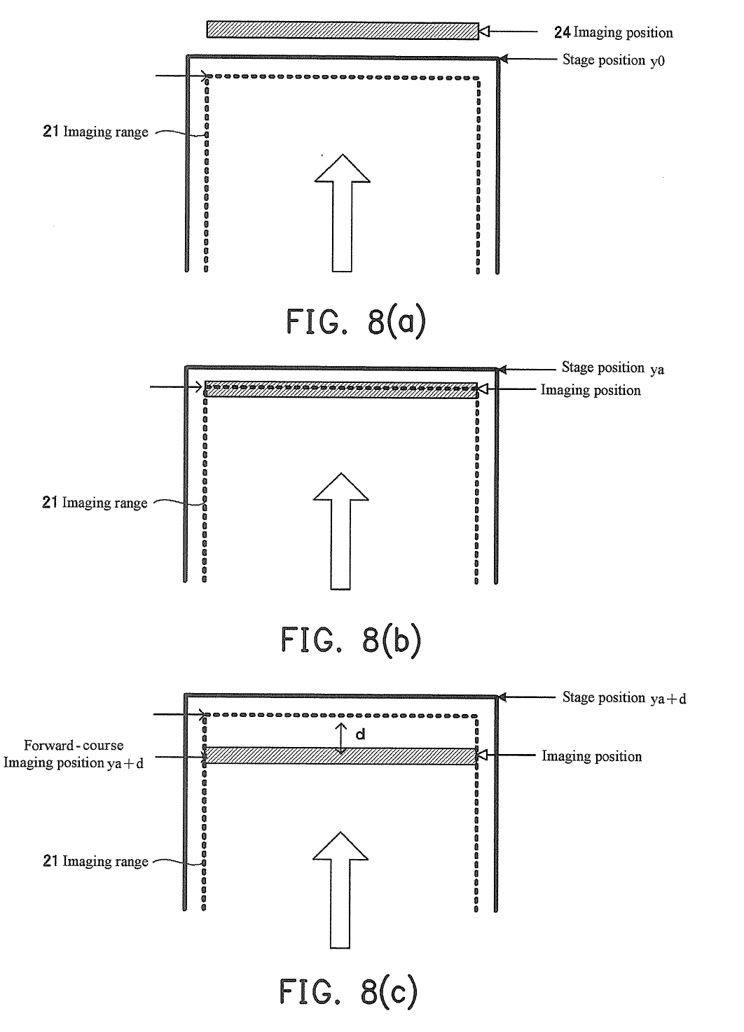

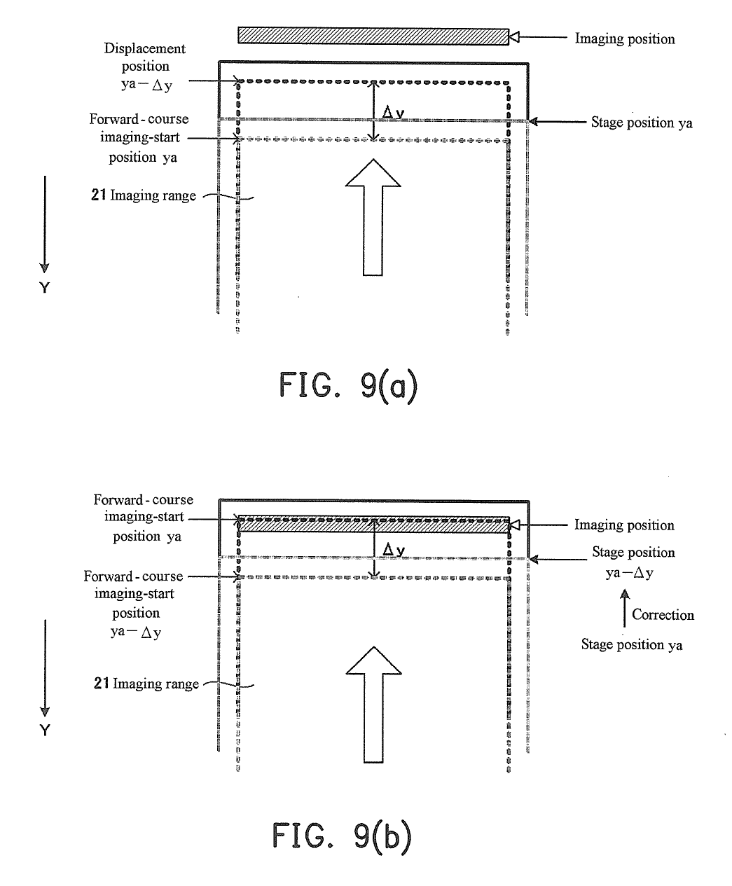

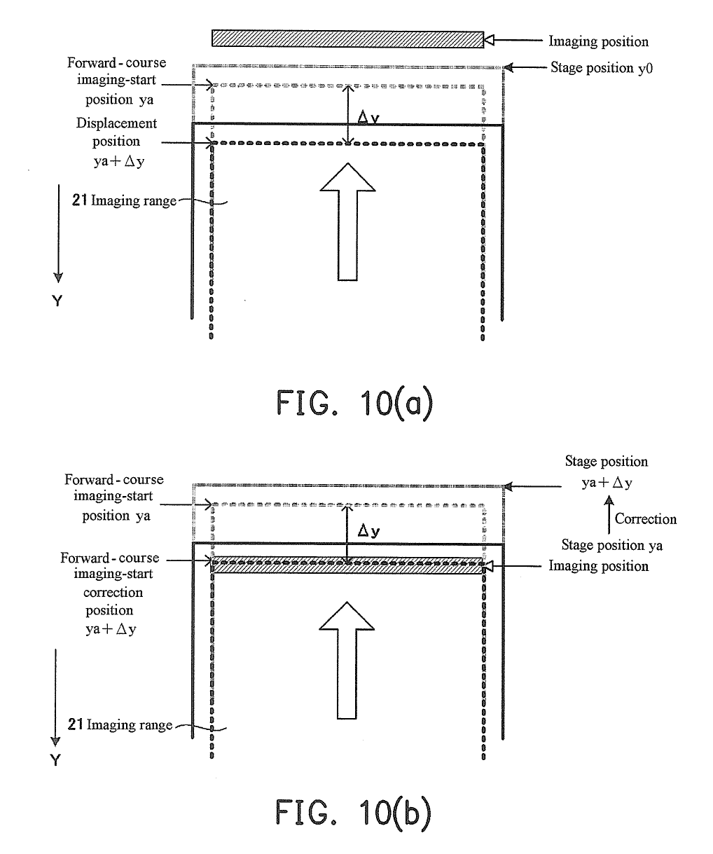

Hereinafter, FIG. 3˜FIG. 10(a) and FIG. 10(b) illustrate the actions of the liquid crystal array inspection apparatus 1 of the present invention. FIG. 3 is a schematic view illustrating the to-and-fro stage movement of the liquid crystal array inspection apparatus 1 of the present invention, and FIG. 4(a), FIG. 4(b)˜FIG. 7(a), FIG. 7(b) are views illustrating the imaging of the to-and-fro stage movement. In addition, FIG. 8(a) to FIG. 8(c) and FIG. 9 are views illustrating the correction on the imaging range.

In FIG. 3, the liquid crystal array inspection apparatus 1 performs imaging on the imaging range 21 (denoted by the dash line) of the liquid crystal substrate configured on the stage 20. In the course of the imaging operation, the stage 20 is moved to-and-fro in the Y direction, and the imaging is performed along all paths of the forward course 22 and the return course 23. For the range of the Y direction of the imaging range 21, the forward course 22 depends on the range enclosed by the forward course imaging-start position 31 (xa, ya) and the forward course imaging-stop position 32 (xa, yb), and the return course 23 depends on the range enclosed by the return-course imaging-start position 33 (xb, yb) and the return-course imaging-stop position 34 (xb, ya). Furthermore, the forward-course imaging-start position 31 (xa, ya) and the return-course imaging-stop position 34 (xb, ya) are at the same position in the Y direction, and the forward-course imaging-stop position 32 (xa, yb) and the return-course imaging-start position 33 (xb, yb) are at the same position in the Y direction. The imaging range 21 may also be determined according to different positions in the Y direction.

In FIG. 4(a), FIG. 4(b) to FIG. 7(a) and FIG. 7(b), the imaging position 24 is the position for disposing the imaging device, the position y0 of the Y direction is a fixed position relative to the liquid crystal array inspection apparatus 1. On the other hand, the forward-course imaging-start position 31 (xa, ya), the forward-course imaging-stop position 32 (xa, yb), the return-course imaging-start position 33 (xb, yb), and the return-course imaging-stop position 34 (xb, ya) are positions on the stage 20, and these positions are moved in the Y direction relative to the position y0 of the Y direction of the imaging position 24 along with the movement of the stage 20. By the relative movement of the imaging position 24 and the stage 20, the imaging range of the liquid crystal substrate carried on the stage 20 is imaged.

Furthermore, in FIG. 4(a) and FIG. 4(b) to FIG. 7(a) and FIG. 7(b), the stage 20 moves in the upward direction in the figures to perform the imaging of the forward course, and the stage 20 moves in the downward direction in the figures to perform the imaging of the return course.

FIG. 4(a) illustrates the state that the forward-course imaging-start position 31 does not reach the imaging position 24. FIG. 4(b) illustrates the following state, in which the stage 20 moves in the upward direction in the figure from the state of FIG. 4(a), and the forward-course imaging-start position 31 reaches the imaging position 24.

The imaging-start position reaching detection part 11 is used to determine whether the forward-course imaging-start position 31 reaches the imaging position 24, and the comparator 11b compares the count value with the position information of the forward-course imaging-start position 31 to thereby perform the determination, and the count value is obtained based on the output of the encoder for detecting the drive amount the stage 20.

The imaging-start trigger signal generating part 13a of the Y-axis synchronizing unit 13 receives the comparison result and sends the imaging-start trigger signal to the imaging control part 12. After the imaging control part 12 receives the imaging-start trigger signal, the imaging device 2 is controlled to start imaging.

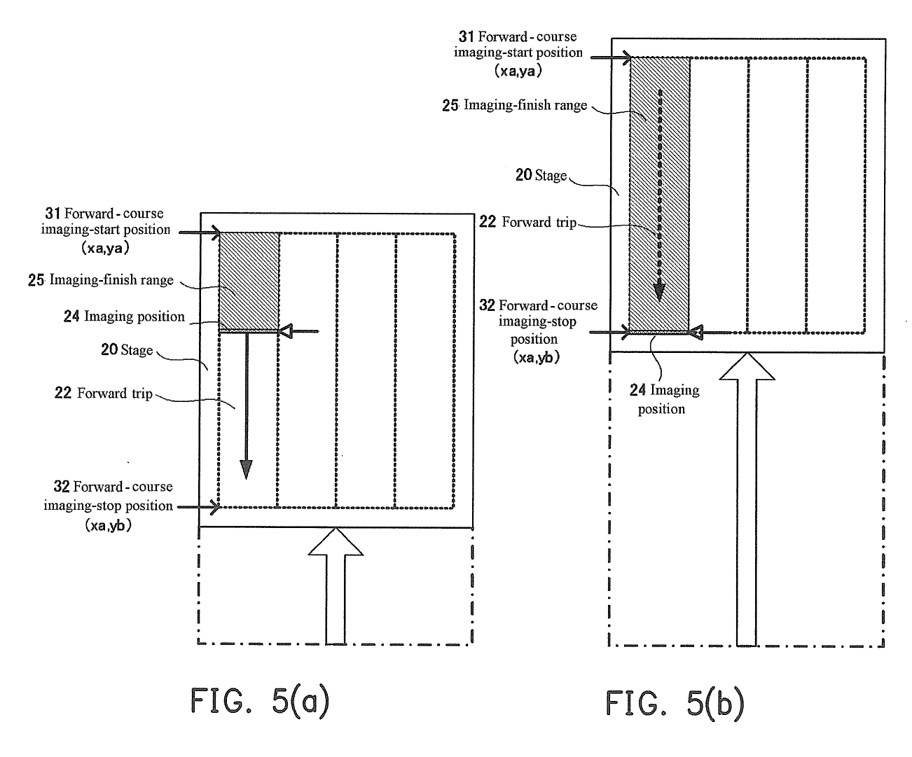

FIG. 5(a) illustrates the imaging state in the forward course. The imaging-finish range 25 in FIG. 5(a) illustrates the range imaged by the imaging device 2 in the imaging range 21 because of the movement of the stage 20.

FIG. 5(b) illustrates the state that the imaging of the forward course is finished, and the state that the forward-course imaging-stop position 32 reaches the imaging position 24 since the stage 20 moves. The imaging-finish range 25 in FIG. 5(b) takes the entire imaging range 21 as the imaging-finish range.

Since the stage 20 moves, after the forward-course imaging-stop position 32 reaches the imaging position 24, the moving direction of the stage 20 is reversed and performs imaging along the return course. In the course of reversing from the forward course to the return course, the imaging position 24 moves to the adjacent path. For example, the stage 20 moves in the X direction, thereby the imaging position 24 moves to the adjacent path. Alternatively, the stage 20 moves in the X direction, and the imaging device 2 may also move in the direction opposite to the X direction.

The imaging-start position reaching detection part 11 is used to determine whether the forward-course imaging-stop position 32 reaches the imaging position 24, and the comparator 11b compares the count value with the position information of the forward-course imaging-stop position 32 to thereby perform the determination, and the count value is obtained based on the output of the encoder for detecting the drive amount of the stage 20.

The imaging-start trigger signal generating part 13a of the Y-axis synchronizing unit 13 receives the comparison result and sends an imaging-stop trigger signal to the imaging control part 12. After the imaging control part 12 receives the imaging-stop trigger signal, the imaging device 2 is controlled to stop imaging.

After the imaging position 24 is moved to the next path, the imaging of the return course is performed. The imaging of the return course may be performed in the same manner as the imaging of the forward course.

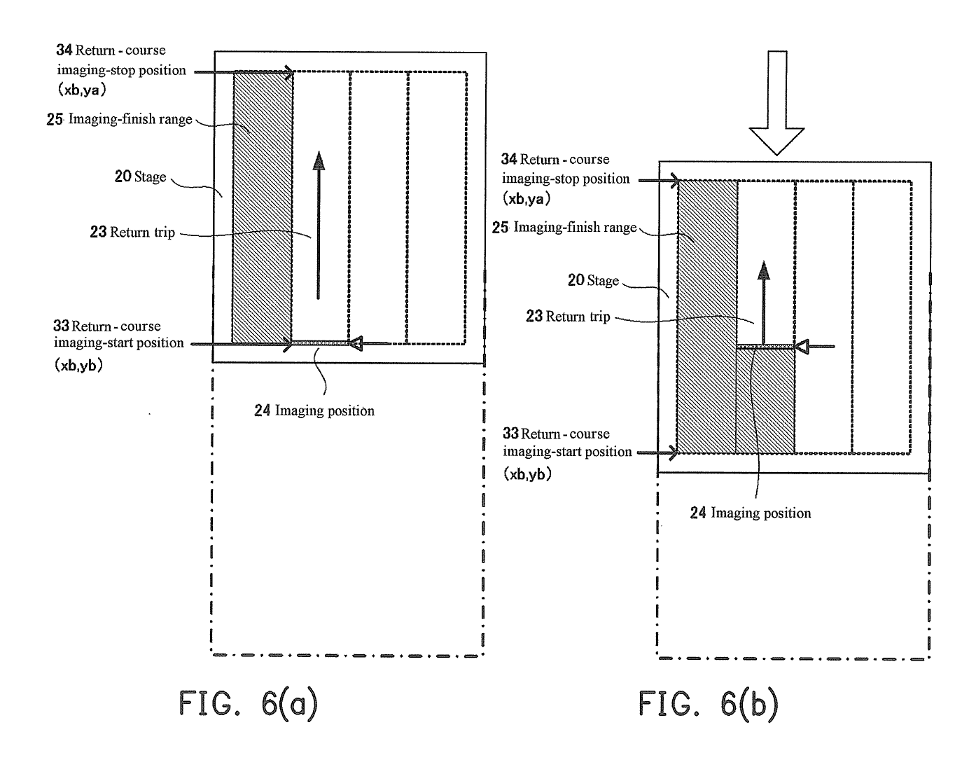

FIG. 6(a) illustrates the following state, in which the stage 20 moves in the left direction in the figure from the state of FIG. 5(b), and the imaging position 24 is moved to the next path.

The imaging-start position reaching detection part 11 is used to determine whether the return-course imaging-start position 33 reaches the imaging position 24, and the comparator 11b compares the count value with the position information of the return-course imaging-start position 33 to thereby perform the determination, and the count value is obtained based on the output of the encoder for detecting the drive amount the stage 20.

The imaging-start trigger signal generating part 13a of the Y-axis synchronizing unit 13 receives the comparison result and sends the imaging-start trigger signal to the imaging control part 12. After the imaging control part 12 receives the imaging-start trigger signal, the imaging device 2 is controlled to start imaging.

Furthermore, in FIG. 6(a), the forward-course imaging-stop position and the Y direction position of the return-course imaging-start position are the same, so the stage 20 may move to the next path in the X direction without moving in the Y direction to reach the imaging-start position.

When the forward-course imaging-stop position 32 and the return-course imaging-start position 33 are different positions in the Y direction, the stage 20 moves until the return-course imaging-start position 33 reaches the imaging position 24.

FIG. 6(b) illustrates the imaging state in the return course. The imaging-finish range 25 in FIG. 6(b) indicates the range imaged by the imaging device 2 in the imaging range 21 because of the movement of the stage 20.

FIG. 7(a) illustrates the state that the imaging of the return course is finished. Since the stage 20 moves, the return-course imaging-stop position 34 reaches the imaging position 24. The imaging-finish range 25 in FIG. 7(a) takes the entire imaging range 21 as the imaging-finish range.

Since the stage 20 moves, after the return-course imaging-stop position 34 reaches the imaging position 24, the moving direction of the stage 20 is reversed and imaging along the forward course is performed. In the course of reversing from the return course to the forward course, as described above, the imaging position 24 moves to the adjacent path.

The imaging-start position reaching detection part 11 is used to determine whether the return-course imaging-stop position 34 reaches the imaging position 24, and the comparator 11b compares the count value with the position information of the return-course imaging-stop position 34 to thereby perform the determination, and the count value is obtained based on the output of the encoder for detecting the drive amount the stage 20.

The imaging-start trigger signal generating part 13a of the Y-axis synchronizing unit 13 receives the comparison result and sends the imaging-stop trigger signal to the imaging control part 12. After the imaging control part 12 receives the imaging-stop trigger signal, the imaging device 2 is controlled to stop imaging.

After the imaging position 24 moves to the next path, the imaging of the next forward course is performed. The imaging of the next forward course may be in the same manner as the imaging of the forward course.

FIG. 7(b) illustrates the following state, that is, the stage 20 moves in the left direction in the figure from the state of FIG. 7(a), and the imaging position 24 moves to the next path.

The imaging-start position reaching detection part 11 is used to determine whether the forward-course imaging-start position 31 reaches the imaging position 24, and the comparator 11b compares the count value with the position information of the return-course imaging-start position 33 to thereby perform the determination, and the count value is obtained based on the output of the encoder for detecting the drive amount the stage 20.

The imaging-start trigger signal generating part 13a of the Y-axis synchronizing unit 13 receives the comparison result and sends the imaging-start trigger signal to the imaging control part 12. After the imaging control part 12 receives the imaging-start trigger signal, the imaging device 2 is controlled to start imaging. Likewise, the imaging of the forward and return courses is repeated to thereby perform the imaging of the entire imaging range of the liquid crystal substrate.

Then, FIG. 8(a) to FIG. 8(c)˜FIG. 10(a) and FIG. 10(b) illustrate a correction on the displacement. FIG. 8(a) to FIG. 8(c) illustrate the situation without the displacement, FIG. 9(a), FIG. 9(b) illustrate the position of the substrate which is deviated from the preset position to the upward direction in the figures, and FIG. 10(a) and FIG. 10(b) illustrate the position of the substrate which is deviated from the preset position to the downward direction in the figures.

Furthermore, in FIG. 8(a) to FIG. 8(c)˜FIG. 10(a) and FIG. 10(b), the forward-course imaging-start position ya indicates a position on the liquid crystal substrate, and the stage position indicates the position of the stage by taking the liquid crystal array inspection apparatus as a reference. In addition, in FIG. 8(a) to FIG. 8(c)˜FIG. 10(a) and FIG. 10(b), the downward direction in the figures indicates an increasing direction in the Y direction.

FIG. 8(a) to FIG. 8(c) illustrate the following situation, in which the substrate introduced into the liquid crystal array inspection apparatus is carried on the stage at the preset position, and there is no displacement between the substrate and the preset position.

FIG. 8(a) illustrates the state that the forward-course imaging-start position 31 does not reach the imaging position 24. FIG. 8(b) illustrates the following state, in which the stage 20 moves in the upward direction in the figure from the state of FIG. 8(a), and the forward-course imaging-start position 31 reaches the imaging position 24. The states of FIG. 8(a) and FIG. 8(b) are the same as the states of FIG. 4(a) and FIG. 4(b). FIG. 8(c) illustrates the imaging state of the forward course, and the stage position “ya+d” indicates the stage position “ya” only moves by d in the Y direction.

When the position of the substrate is deviated from the preset position in the upward direction in the figures, as shown in FIG. 9(a) and FIG. 9(b), the imaging-start position of the liquid crystal substrate is deviated to a position closer to the up position of the figures compared with the original preset imaging-start position ya. FIG. 9(a) illustrates the state after the displacement, in which the thick solid line indicates the liquid crystal substrate position after the displacement, and the thin solid line indicates the original preset liquid crystal substrate position.

Here, the forward trip imaging-start position of the liquid crystal substrate after the displacement is deviated to the negative direction of the Y direction (the upward direction in the figure) from the forward trip imaging-start position “ya” without displacement, so it is indicated by “ya−Δy”.

For the displacement, the stage position is corrected by adding “ya” and the amount of displacement “−Δy” so as to form the forward-course imaging-start position “ya−Δy”. Thus, the displacement of the substrate is corrected, and the substrate is imaged. FIG. 9(b) illustrates the state after the correction.

In addition, when the position of the substrate is deviated from the preset position to the downward direction in the figures, as shown in FIG. 10(a) and FIG. 10(b), the imaging-start position of the liquid crystal substrate is deviated to a position which is closer to the downward position in the figures compared with the original preset imaging-start position ya. FIG. 10(a) illustrates the state after the displacement, in which the thick solid line indicates the liquid crystal substrate position after the displacement, and the thin solid line indicates the original preset liquid crystal substrate position.

Here, the forward-course imaging-start position of the liquid crystal substrate after the displacement is deviated to the positive direction of the Y direction (the downward direction in the figure) from the forward-course imaging-start position “ya” without displacement, so it is indicated by “ya+Δy”.

For the displacement, the stage position is corrected by adding “ya” and the amount of displacement “+Δy” so as to form the forward-course imaging-start position “ya+Δy”. Thus, the displacement of the substrate is corrected, and the substrate is imaged. FIG. 10(b) illustrates the state after the correction.

The amount of displacement may be acquired according to the alignment information, and the correction calculation may be performed in the correction part 11g.

### INDUSTRIAL APPLICABILITY

The scan beam apparatus of the present invention is applicable to an electron ray micro-analyzer, a scanning electron microscope, an X-ray analysis apparatus or the like.

1. A liquid crystal array inspection apparatus, for acquiring an imaging picture by scanning a liquid crystal substrate in a two-dimensional manner and inspecting the liquid crystal substrate array based on the imaging picture, comprising:
a stage, for carrying the liquid crystal substrate and moving to-and-fro in a Y direction;
an imaging device, configured above the stage and separated from the stage;
an imaging control part, for controlling an imaging of the imaging device;
a stage driving part, for driving the stage in the Y direction;
an encoder, for detecting a rotation state of a drive motor of the stage driving part;
an imaging-start position reaching detection part, for detecting that the liquid crystal substrate on the stage reaches imaging-start positions of forward and return trips in the Y direction based on a detection value and an imaging range of the encoder; and
an imaging-start trigger signal generating part, for generating an imaging-start trigger signal for the imaging control part to start the imaging of the imaging device based on an output of the imaging-start position reaching detection part,
wherein after the imaging control part receives the image-start trigger signal generated by the imaging-start trigger signal generating part, the imaging device starts the imaging, so that positions of the forward and return courses of the stage in the Y direction and the imaging-start position of the imaging device are synchronized.

2. The liquid crystal array inspection apparatus according to claim 1, wherein:
the imaging-start position reaching detection part comprises:
a counter part, for counting a count value equivalent to a moving distance of the stage according to a detection signal obtained after an A-phase signal and a B-phase signal of the encoder that are shifted 90° relative to each other; and
a comparator, for comparing a value, equivalent an end position in the Y direction of the imaging range on the liquid crystal substrate, with the count value obtained by the counter part,
wherein in the comparison of the comparator, when the value equivalent to the end position is consistent with the count value equivalent to the moving distance of the stage, the imaging-start trigger signal generating part generates the imaging-start trigger signal based on a consistent signal generated by the comparator.

3. The liquid crystal array inspection apparatus according to claim 1, wherein:
the imaging-start position reaching detection part comprises a memory, for storing imaging range information of the liquid crystal substrate with relation to substrate type information that particularly designates a type of the liquid crystal substrate,
wherein the imaging-start position reaching detection part reads, based on the substrate type information, the value equivalent to the end position in the Y direction of the imaging range on the liquid crystal substrate from the imaging range information, stored in the memory, of the liquid crystal substrate.

4. The liquid crystal array inspection apparatus according to claim 2, wherein:
the imaging-start position reaching detection part comprises a correction part, for inputting alignment information of the liquid crystal substrate, adding an amount of displacement of the liquid crystal substrate of the alignment information to an imaging range position, and performing a correction on the end position in the Y direction of the imaging range on the liquid crystal substrate.

5. The liquid crystal array inspection apparatus according to claim 3, wherein:
the imaging-start position reaching detection part comprises a correction part, for inputting alignment information of the liquid crystal substrate, adding an amount of displacement of the liquid crystal substrate of the alignment information to an imaging range position, and performing a correction on the end position in the Y direction of the imaging range on the liquid crystal substrate.
